(19) United States
(12) Patent Application Publication
(10) Pub. No.: US 2011/0314453 A1
(43) Pub. Date: Dec. 22, 2011

(54) REAL TIME PROFILING OF A COMPUTER SOFTWARE APPLICATION RUNNING ON PARALLEL COMPUTING RESOURCES

(75) Inventors: Yaki TEBEKA, Kfar Hes (IL); Avi SHAPIRA, Tel Aviv (IL); Uri SHOMRONI, Tel Aviv (IL); Sigal ALGRANATY, Ramat Gan (IL)

(73) Assignee: GRAPHIC REMEDY LTD., Tel Aviv (IL)

(21) Appl. No.: 12/819,539

(22) Filed: Jun. 21, 2010

(51) Int. Cl. G06F 9/44

(52) U.S. Cl. 717/130

(57) ABSTRACT

A method of real-time profiling a software application running on heterogeneous parallel computing resources is provided. The method may include the following steps, comprising: analyzing, in real-time, operations of a computer software application operatively associated with parallel computing resources, by executing the application on the parallel computing resources in a specified configuration of parallel computing resources usage, to yield a time-dependent profile of the computer software application in terms of usage of the parallel computing resources, wherein the profile is based on specified categories of software operations; presenting the time-dependent profile graphically and in real-time; repeating the executing with a modified configuration in response to user modifications made to the usage of the parallel computing resources, to yield an updated profile; and repeating the presenting with the updated profile, wherein at least one of the analyzing, the presenting and the repeating is executed by at least one processor.

### BACKGROUND

1. Technical Field

The present invention relates to a software analysis and more particularly, to software analysis applied to usage of parallel computing recourses by a computer software application.

2. Discussion of the Related Art

Parallel computing hardware resources are becoming more and more available for software developers enabling them to use these resources in high performance software applications. Developing high performance software application requires an ongoing process of software optimizations and therefore requires a close look on how the software interacts and uses the hardware computing resources.

For this end, several software development tools providing application profiling capabilities have been developed. Some of these profiling tools analyze the usage of a specified software application of a platform specific parallel computing resources, while the analysis is performed off line.

### BRIEF SUMMARY

One aspect of the invention provides a method of real-time profiling a software application running on heterogeneous parallel computing resources. The method may include the following step: comprising: analyzing, in real-time, operations of a computer software application operatively associated with parallel computing resources, by executing the application on the parallel computing resources in a specified configuration of parallel computing resources usage, to yield a time-dependent profile of the computer software application in terms of usage of the parallel computing resources, wherein the profile is based on specified categories of software operations; presenting the time-dependent profile graphically and in real-time; repeating the executing with a modified configuration in response to user modifications made to the usage of the parallel computing resources, to yield an updated profile; and repeating the presenting with the updated profile, wherein at least one of the analyzing, the presenting and the repeating is executed by at least one processor.

Other aspects of the invention may include a system arranged to execute each of the aforementioned method, a computer network comprising a plurality of the aforementioned gateways, and a computer readable program configured to execute each of the aforementioned method or a combination thereof. These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating an aspect of a system consistent with an embodiment of the invention;

FIG. 2 is a high level flowchart diagram illustrating an aspect of a method consistent with an embodiment of the invention; and

FIG. 3 is a diagram illustrating an exemplary graphical user interface consistent with an embodiment of the invention.

The drawings together with the following detailed description make apparent to those skilled in the art how the invention may be embodied in practice.

### DETAILED DESCRIPTION

Prior to setting forth the detailed description, it may be helpful to set forth definitions of certain terms that will be used hereinafter.

The term “Parallel Computing” as used herein in this application refers to a form of computation in which many calculations are carried out simultaneously, operating on the principle that large problems can often be divided into smaller ones, which are then solved concurrently (“in parallel”). There are several different forms of parallel computing such as data and task parallelism.

The term or “software profiling” or “profiling” as used herein in this application refers to a form of dynamic program analysis (as opposed to static code analysis), is the investigation of a program's behavior using information gathered as the program executes. The usual purpose of this analysis is to determine which sections of a program to optimize—to increase its overall speed, decrease its memory requirement or sometimes both.

The term “Open Computing Language” or “OpenCL” as used herein in this application refers to a framework for writing programs that execute across heterogeneous platforms consisting of CPUs, GPUs, and other processors. OpenCL includes a language for writing kernels (functions that execute on OpenCL devices), plus APIs that are used to define and then control the platforms. OpenCL provides parallel computing using task-based and data-based parallelism.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

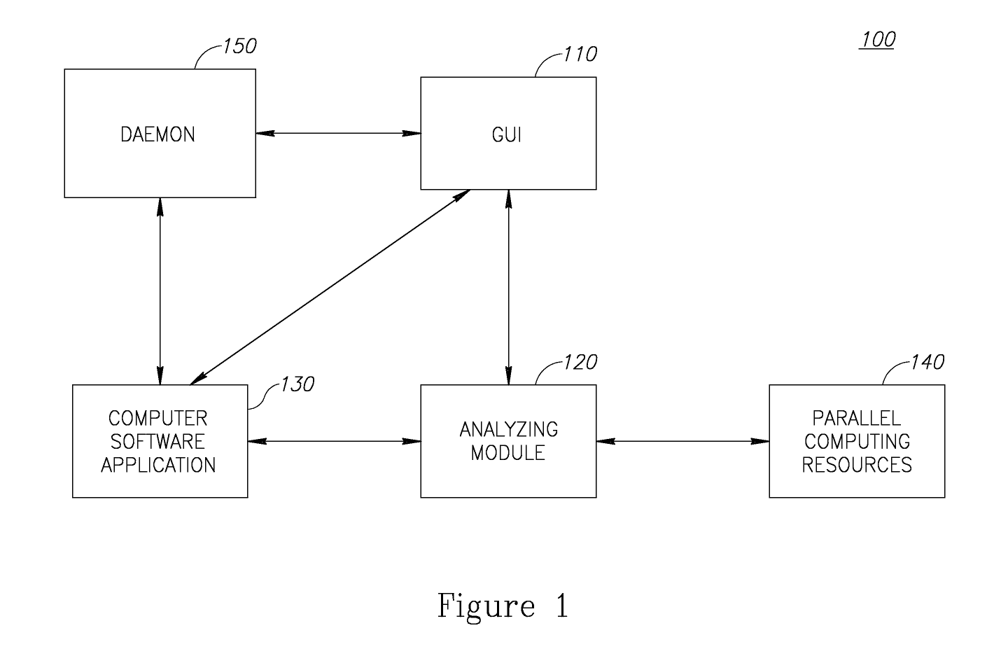

FIG. 1 is a high level schematic block diagram illustrating an aspect of a system consistent with an embodiment of the invention. System 100 may include an analyzing module 120 that may be implemented as a remote server and connected over a network to a graphic user interface (GUI) 110. Alternatively, analyzing module 120 and GUI 110 are physically located at the same computer. Analyzing module 120 is in operative association with parallel computing resources 130 having a computer software application 140 running thereon. In the case that analyzing module 120 resides on a remote computer, a daemon 150 in operative association with GUI 110, launches the computer software application 140 in order to monitor and control it.

In operation, analyzing module 120 is configured to analyze, in real-time, operations of computer software application 130 running on parallel computing resources 140, by executing application 130 on parallel computing resources 140 in a specified configuration of parallel computing resources usage, to yield a time-dependent profile of the computer software application in terms of usage of the parallel computing resources. The aforementioned profile is based on specified categories of software operations. GUI 110 is configured to present the time-dependent profile graphically and in real-time. Additionally, analyzing module 120 is further configured to repeat the executing with a modified configuration in response to user modifications to the usage of the parallel computing resources, to yield an updated profile. Further additionally, GUI 110 is configured to repeat the presenting with the updated profile. This process of repeating the executing and repeating the presenting can be carried out over a specified time as required by the software developer (the user) by which the user may receive valuable information regarding the bottlenecks of the operation of software application 130 as implemented over parallel computing resources 140 in the specified configuration.

Consistent with one embodiment of the invention, GUI 110 may further be configured to present a graphic output of the computer software application, to yield a combined profile-output view, in case such graphic output exists, wherein the combined profile-output view is useable for determining impact of the user modifications on the parallel computing resources and software application.

Consistent with one embodiment of the invention, user modifications comprises at least one of: enabling at least one parallel computing resource, disabling at least one parallel computing resource, enabling at least one software operation of the specified categories of software operations; and disabling at least one software operation of the specified categories of software operations.

Consistent with one embodiment of the invention, the specified categories of software operations comprise: read operations; write operations; copy operations; and kernel operations

Consistent with one embodiment of the invention, the profile comprises performance of the computer software application in terms of, for example, amount of computing kernel executions per time units, read, write and copy MB/sec.

Consistent with one embodiment of the invention, analyzing module is further configured to interface arbitrarily with the computer software application and the parallel computing resources to enable a platform independent analysis.

Consistent with one embodiment of the invention, the configuration of parallel computing resources usage comprises allocation of alternative computing resources for specified computing tasks, wherein the allocating is user controlled.

Consistent with some embodiments of the invention a user may force work group size which refers the distribution of processing kernel executions over the parallel computing resources. This can be done either manually or automatically. In a manual configuration, the user selects the way kernels are grouped for execution over the parallel computing resources. In an automatic configuration, the user instructs GUI 110, which in turn instructs analyzing module 120 to automatically select the way kernels are grouped for execution over parallel computing resources 140. System 100 then tries different grouping options and eventually displays the results having the most optimal grouping option achieved.

Consistent with some embodiments of the invention, the profiling data may be displayed over GUI 110 either globally, for the entire parallel computing resources 140 or for each one of the parallel computing resources in a “per device” representation.

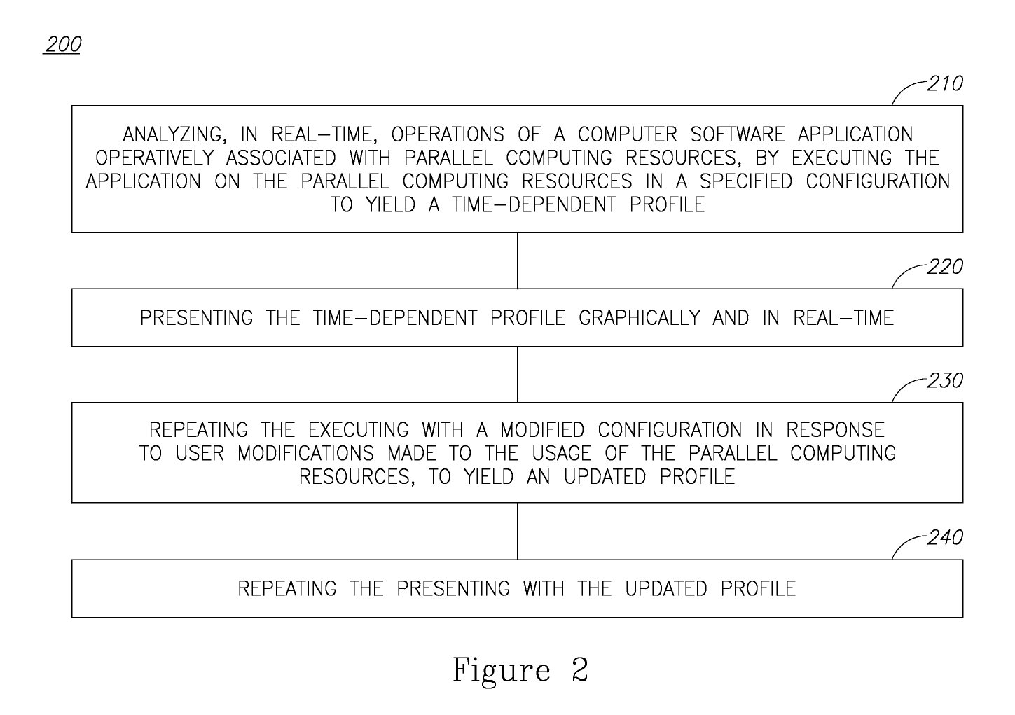

FIG. 2 is a high level flowchart diagram illustrating an aspect of a method consistent with an embodiment of the invention. Method 200 may include the following steps: analyzing, in real-time, operations of a computer software application operatively associated with parallel computing resources, by executing the application on the parallel computing resources in a specified configuration of parallel computing resources usage, to yield a time-dependent profile of the computer software application in terms of usage of the parallel computing resources, wherein the profile is based on specified categories of software operations 210. Method 200 then goes on the step of presenting the time-dependent profile graphically and in real-time 220. Then the method goes on with repeating the executing with a modified configuration in response to user modifications made to the usage of the parallel computing resources, to yield an updated profile. Finally, method 200 goes on to repeating the presenting with the updated profile, wherein at least one of the analyzing, the presenting and the repeating is executed by at least one processor.

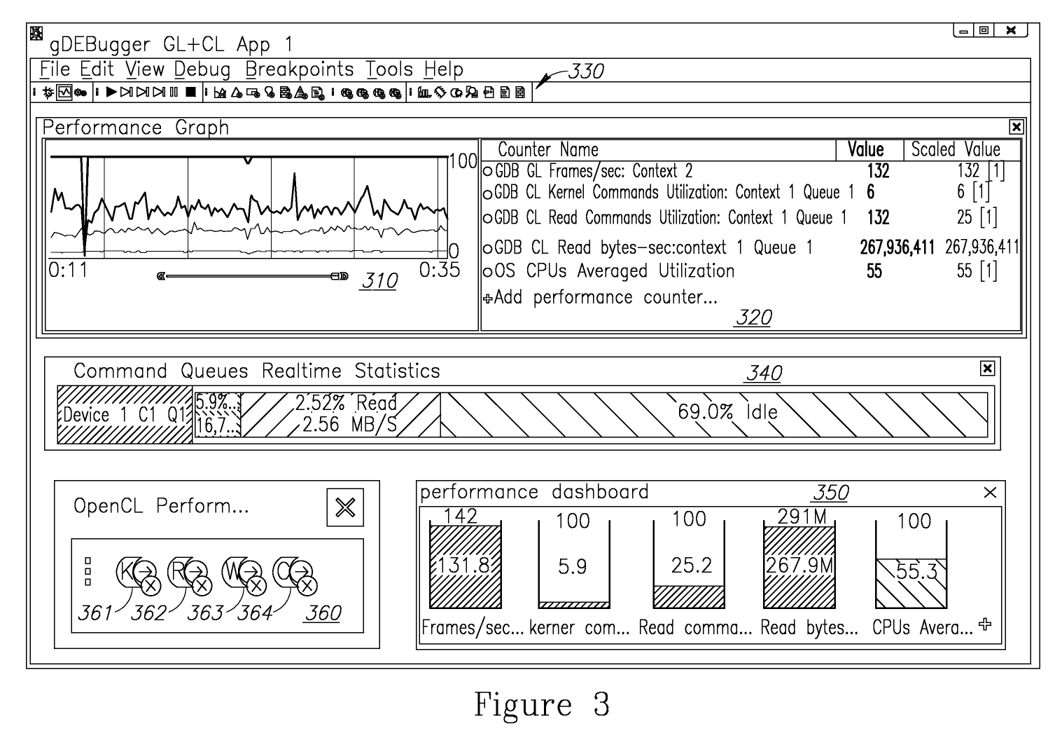

FIG. 3 is a diagram illustrating an exemplary graphical user interface consistent with an embodiment of the invention. GUI 110 may include a toolbar 330 for manipulating the configuration of parallel computing resources 140 in regards with a running software application 130 being profiled. Performance of a running software application 130 can be displayed as a performance graph 310 in which different plots show usage of different type of commands in terms of the allocation of parallel computing resources, the unitization of parallel computing resources and other performance counters 140. Performance may also be displayed a bar diagram 340 or bars diagram 350.

The following is a more detailed description of the operation of system 100 consistent with the embodiments of the invention and explained in reference to the aforementioned FIGS. 1-3.

Initially, the user launches system 100 wherein analyzing module 120 and GUI 110 are either located physically on the same computer or remotely connected over a network. The combination of analyzing module 120 and GUI 110 constitutes the profiling tool. Then the user selects the software application 130 constituting the profiled application. GUI module 110 then launches software application 130. Upon launch, GUI module 110 loads analyzing module 120 as a dynamic module into the process of software application 130. Analyzing module 120 intercepts all OpenCL calls performed by software application 130. Analyzing module 120 further establishes a socket connection with GUI 110. This connection can be based on native socket implementation, TCP IP, shared memory or any other connection type.

Upon establishing communication, analyzing module 120 captures all OpenCL enqueued commands and measures for each command the command's type, type specific parameters, enqueue time, submission time, execution time and duration. Analyzing module 120 further captures, for each OpenCL device and queue, the amount of processed work items. Analyzing module 120 captures, for each OpenCL device and queue, the amount of MB written into OpenCL buffers and images. Analyzing module 120 further captures, for each OpenCL device and queue, the amount of MB read from OpenCL buffers and images. Analyzing module 120 captures, for each OpenCL device and queue, the amount of MB copied between OpenCL buffers and images.

Then, the user may be prompted by GUI 110 to set an interval (“sampling interval”) in which the analyzing module 120 will sample OpenCL activities. At each sampling interval, analyzing module 120 queries the OpenCL for the last N (e.g., 100) enqueued OpenCL commands parameters. Analyzing module 120 may divide the last enqueued N commands into the following categories: Kernel commands, Write commands, Copy commands, Read Commands, Other commands. Analyzing module 120 then computes an overview of the time in which the last N commands were enqueued (“time interval”). This time frame may be divided into the following parts: Kernels execution time, Write commands execution time, Copy commands execution time, Read commands execution time, other commands execution time and idle time. Analyzing module 120 calculates, for each device and queue, regarding the amount of work items executed by kernels in the time interval. Analyzing module 120 calculates for each device and queue, the amount of MB written into OpenCL buffers and images. Analyzing module 120 calculates, for each device and queue, the amount of MB read from OpenCL buffers and images. Analyzing module 120 calculates, for each device and queue, the amount of MB copied between OpenCL buffers and images.

After processing the aforementioned data received from OpenCL, analyzing module 120 sends the data to the GUI 110 to present a real time statistics view (“real time statistics view”) exhibiting the above collected information (“collected statistics”).

After the presenting, the user may instruct analyzing module 120, using GUI 110 (specifically, buttons set 361) to disable all kernel execution operations. In such a case, analyzing module 120 may instruct analyzing module 120 to ignore all kernel execution related commands. The user can then see the effect of disabling all kernel operations by viewing the real time statistics view over GUI 110.

Similarly, the user can instruct analyzing module 120, using GUI 110 (specifically, buttons set 361) to enable kernel execution operations. The user can select a kernel and instruct analyzing module 120 to disable all execution operations related to this specific kernel. In such a case, the client asks analyzing module 120 to ignore the execution of operations related the selected kernel. The user can then see the effect of disabling the selected kernel operations by viewing the real time statistics view over GUI 110.

In addition, the user may instruct analyzing module 120 to enable the selected kernel operations. The user may instruct analyzing module 120 to disable all read operations, in this case, analyzing module 120 ignore all enqueued read commands. The user can then see the effect of disabling all read operations by viewing the real time statistics view over GUI 110.

The user may instruct analyzing module 120 to enable read operations (specifically, buttons set 362 of GUI 110). The user may instruct Analyzing module 120 120 to disable all write operations, in this case, analyzing module 120 ignore all enqueued write commands. The user can then see the effect of disabling all write operations by viewing the real time statistics view over GUI 110. The user may also analyzing module 120 to enable write operations (specifically, buttons set 363 of GUI 110). The user may also instruct analyzing module 120 to disable all copy operations (specifically, buttons set 364 of GUI 110). In such a case, analyzing module 120 ignore all enqueued copy commands. The user can then see the effect of disabling all copy operations by viewing the real time statistics view over GUI 110. The user may instruct analyzing module 120 to enable copy operations.

Consistent with embodiments of the invention, the user may also select, over GUI 110, a buffer or an image and may instruct analyzing module 120 to disable all read/write/copy operations related to this specific buffer/image. In such a case, analyzing module 120 ignores the execution of read/write/copy operations related the selected buffer/image. The user can then see the effect of disabling read/write/copy operations on the selected buffer/image operations by viewing the real time statistics view over GUI 110. The user may instruct analyzing module 120 to enable the selected buffer/image read/write/copy operations.

Consistent with embodiments of the invention, the user may set the kernel execution workgroup size. The user can select a kernel and ask the client to set the size of the work-group executing the kernel, in this case, the client asks analyzing module 120 to force the selected work-group size on each OpenCL enqueued command that executes a kernel on a device. The user can then see the effect of forcing a workgroup size on the selected kernel by viewing the real time statistics view over GUI 110. The user can ask the client to remove the forced work group size restriction.

Consistent with embodiments of the invention, the user may edit portions of the computer code associated with a given Kernel 140 and repeat the execution of the edited code. Specifically, the user may select an OpenCL program and edit its source code in a special source code editor, provided over GUI 110. When the editing is finished, the user can instruct analyzing module 120 to recompile the program. In such a case, GUI 110 instructs Analyzing module 120 to set new source code for the selected program. Analyzing module 120 then compiles the program for all the devices of parallel computing resources 140 in which it was used or compiled to and replace the kernels associated with the program with kernels relating to the new program's binary code. The user can then see the effect of setting the program's source code by viewing the real time statistics view over GUI 110. Similarly, the user may replace the code of a binary program, with a binary program generated from his source code. Alternatively, the user can replace the code of a binary program, with a binary program. The user may also restore the OpenCL program's original source/binary code.

Consistent with embodiments of the invention, the user may force execution on a selected device of parallel computing resources 140. For example, the user may force the execution of a selected kernel on a selected device. In such a case, GUI 110 instructs analyzing module 120 to force the selected kernel's execution on the selected device. Analyzing module 120 creates a new program, based on the program related to the selected kernel, compiles it to the selected device, creates a new kernel to be executed on the selected device, and if needed, creates a command queue for the selected device. Whenever the profiled program enqueues the selected kernel on any device, analyzing module 120 will instead enqueue the kernel it created to be executed on the selected device. The user can then see the effect of forcing the selected kernel to run on the selected device over GUI 110. The user may instruct analyzing module 120 at any point, to remove the aforementioned forcing. Alternatively, user may instruct analyzing module 120 to force the execution of all kernels on a given device of parallel computing resources 140.

Consistent with embodiments of the invention, the profiled application 130 may mark the beginning and end of “computation frames” by calling OpenCL extension functions exposed by the analyzing module 120. The term “Computational frame” is used to describe a set of OpenCL API calls, typically the largest set of calls an OpenCL compute context performs which can be considered a single logical operation. The size and scope of a computational frame can be user-defined. Having a notion and boundary of what comprises a frame allows for measurements such as frame times and frame rates as well as API call statistics, which are useful in debugging and profiling. This data is displayed to the user over GUI 110. Also, the real time statistics view can display a computational frames/sec measure.

Consistent with embodiments of the invention, the user may select any device of parallel computing resources 140 and instruct analyzing module 120 to disable it. The user can then see the effect of disabling the device by viewing the real time statistics view over GUI 110. Similarly, the user may instruct analyzing module 120 to enable the selected device.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method comprising:
analyzing, in real-time, operations of a computer software application operatively associated with parallel computing resources, by executing the application on the parallel computing resources in a specified configuration of parallel computing resources usage, to yield a time-dependent profile of the computer software application in terms of usage of the parallel computing resources, wherein the profile is based on specified categories of software operations;
presenting the time-dependent profile graphically and in real-time;
repeating the executing with a modified configuration in response to user modifications made to the usage of the parallel computing resources, to yield an updated profile; and
repeating the presenting with the updated profile, wherein at least one of the analyzing, the presenting and the repeating is executed by at least one processor.

2. The method according to claim 1, wherein the presenting further comprises presenting a graphic output of the computer software application, to yield a combined profile-output view, in case such graphic output exists, wherein the combined profile-output view is useable for determining impact of the user modifications on the parallel computing resources and software application.

3. The method according to claim 1, wherein the user modifications comprises at least one of: enabling at least one parallel computing resource, disabling at least one parallel computing resource, enabling at least one software operation of the specified categories of software operations; disabling at least one software operation of the specified categories of software operations; and determining, manually or automatically, work group size being a distribution of processing kernel executions over the parallel computing resources.

4. The method according to claim 1, wherein the specified categories of software operations comprise: read operations; write operations; copy operations; and kernel operations.

5. The method according to claim 1, further comprising repeating the executing with at least a portion of a computer code associated with the computer software application modified in response to user editing or selecting.

6. The method according to claim 1, wherein the profile comprises performance of the computer software application in terms of at least one of: amount of computing kernel executions per time units; amount of data per time unit of read, copy, and write; and amount of computational frames executed per time units.

7. The method according to claim 1, wherein the analyzing is preceded by interfacing with the computer software application and the parallel computing resources to enable a platform independent analysis.

8. The method according to claim 1, wherein the configuration of parallel computing resources usage comprises user-selected allocation of alternative computing resources for specified computing tasks, wherein the allocating is user controlled.

9. The method according to claim 1, wherein the presenting further comprises at least one of: presenting the profile vis à vis the updated profile; presenting the profile of parallel computing resources in its entirety; and presenting the profile of at least one of the resources selected from parallel computing resources.

10. A system comprising:
an analyzing module; and
a graphical user interface (GUI),
wherein the analyzing module is configured to analyze, in real-time, operations of a computer software application operatively associated with parallel computing resources, by executing the application on the parallel computing resources in a specified configuration of parallel computing resources usage, to yield a time-dependent profile of the computer software application in terms of usage of the parallel computing resources, wherein the profile is based on specified categories of software operations,
wherein the GUI is configured to present the time-dependent profile graphically and in real-time,
wherein the analyzing module is configured to repeat the executing with a modified configuration in response to user modifications to the usage of the parallel computing resources, to yield an updated profile, and
wherein the GUI is configured to repeat the presenting with the updated profile.

11. The system according to claim 10, wherein the GUI is further configured to present a graphic output of the computer software application, to yield a combined profile-output view, in case such graphic output exists, wherein the combined profile-output view is useable for determining impact of the user modifications on the parallel computing resources and software application.

12. The system according to claim 10, wherein user modifications comprises at least one of: enabling at least one parallel computing resource, disabling at least one parallel computing resource, enabling at least one software operation of the specified categories of software operations; disabling at least one software operation of the specified categories of software operations; and determining, manually or automatically, work group size being a distribution of processing kernel executions over the parallel computing resources.

13. The system according to claim 10, wherein the specified categories of software operations comprise: read operations; write operations; copy operations; and kernel operations.

14. The system according to claim 10, wherein the profile comprises performance of the computer software application in terms of amount of computing kernel executions per time units, amount of data per time unit of read, copy, and write.

15. The system according to claim 10, wherein the analyzing module is further configured to interface arbitrarily with the computer software application and the parallel computing resources to enable a platform independent analysis.

16. The system according to claim 10, wherein the configuration of parallel computing resources usage comprises allocation of alternative computing resources for specified computing tasks, wherein the allocating is user controlled.

17. The system according to claim 10, wherein the GUI is further configured to enable a user to edit at least a portion of a computer code associated with the computer software application to yield a modified code, wherein the analyzing module is further reconfigured to execute the modified code on the parallel computing resources to yield an updated profile.

18. A computer program product, the computer program product comprising:
a computer readable storage medium having computer readable program embodied therewith, the computer readable program comprising:
computer readable program configured to analyze, in real-time, operations of a computer software application operatively associated with parallel computing resources, by executing the application on the parallel computing resources in a specified configuration of parallel computing resources usage, to yield a time-dependent profile of the computer software application in terms of usage of the parallel computing resources, wherein the profile is based on specified categories of software operations;
computer readable program configured to present the time-dependent profile graphically and in real-time;
computer readable program configured to repeat the executing with a modified configuration in response to user modifications to the usage of the parallel computing resources, to yield an updated profile; and
computer readable program configured to repeat the presenting with the updated profile.

19. The computer program product according to claim 18, further comprising computer readable program configured to present a graphic output of the computer software application, to yield a combined profile-output view, in case such graphic output exists, wherein the combined profile-output view is useable for determining impact of the user modifications on the parallel computing resources and software application.

20. The computer program product according to claim 18, wherein user modifications comprises at least one of: enabling at least one parallel computing resource, disabling at least one parallel computing resource, enabling at least one software operation of the specified categories of software operations; disabling at least one software operation of the specified categories of software operations; and determining, manually or automatically, work group size being a distribution of processing kernel executions over the parallel computing resources.
